(19) United States
(12) Patent Application Publication
(10) Pub. No.: US 2014/0260667 A1
(43) Pub. Date: Sep. 18, 2014

(54) SYSTEMS AND METHODS FOR ACOUSTIC DETECTION USING FLOW SENSORS

(71) Applicant: Amphenol Corporation, (unknown)

(72) Inventors: Ertugrul Berkcan, Clifton Park, NY (US); Michael Klitzke, Nevada City, CA (US)

(73) Assignee: Amphenol Corporation

(21) Appl. No.: 13/801,201

(22) Filed: Mar. 13, 2013

(51) Int. Cl. G01F 1/66

(52) U.S. Cl. CPC G01F 1/66
USPC 73/861.28

(57) ABSTRACT

Systems and method for acoustic detection using flow sensors are provided. One system includes a flow conduit configured to allow fluid flow therethrough and a flow disrupter configured to impart a flow disturbance to the fluid flow. The system also includes at least one of a first sensor or a second sensor. The first sensor is disposed within the flow conduit at a first position, wherein the first sensor is responsive to first disturbances and configured to generate signals characteristic of the first disturbances. The second sensor is disposed within the flow conduit at a second position, wherein the second sensor is responsive to second disturbances and configured to generate signals characteristic of the second disturbances. The system additionally includes a processor operably coupled to the first and second sensors, wherein the processor is configured to distinguish between signals characteristic of the first and second disturbances.

### BACKGROUND

Ventilation and respiration machines have been used for many years in hospitals, assisted living quarters, and other locations. These devices are often used to treat respiratory ailments. For example, some individuals suffer from some form of respiratory issue during sleep, such as sleep apnea. Many of these people utilize ventilation and/or respiratory machines to assist in nighttime sleeping. Two types of such machines are a continuous positive airway pressure (CPAP) machine and a variable positive airway pressure (VPAP) machine.

When using these ventilation and/or respiratory machines, it is important to be able to accurately determine the flow rate of ventilation and/or respiration. For example, the air supply pressure from these machines is varied based on whether the person is breathing in or out, such as during inspiration and expiration phases of the respiratory system. By properly controlling the air flow during different phases of breathing, as well as when a person is snoring, a more comfortable process results. The more comfortable the ventilation and/or respiratory machine is to a person during use, the more likely the person is to continue to use the ventilation and/or respiratory machine. Users of ventilation and/or respiratory machines may unilaterally decide to cease use of the machine as a result of the machine being uncomfortable during operation, such as when an appropriate air pressure is not supplied, such as during snoring or when the machine is not operating properly.

However, due to the complex nature of breathing and the change in direction and speed of air flow during breathing, it is very difficult to determine flow rates and acoustic conditions, such as snoring.

### BRIEF DESCRIPTION

In accordance with various embodiments, a flow sensor assembly is provided that includes a flow conduit configured to allow fluid flow therethrough and a flow disrupter configured to impart a flow disturbance to the fluid flow. The flow sensor assembly also includes at least one of a first sensor or a second sensor. The first sensor is disposed within the flow conduit at a first position, wherein the first sensor is responsive to first disturbances including at least one of a disturbance of the fluid flow, pressure fluctuations in the flow conduit, acoustic waves, or acoustic energy in the flow conduit, and the first sensor is configured to generate signals characteristic of the first disturbances. The second sensor is disposed within the flow conduit at a second position, wherein the second sensor is responsive to second disturbances including at least one of a disturbance of the fluid flow, pressure fluctuations in the flow conduit, acoustic waves, or acoustic energy in the flow conduit, and the second sensor is configured to generate signals characteristic of the second disturbances. The flow sensor assembly additionally includes a processor operably coupled to the first and second sensors, wherein the processor is configured to distinguish between signals characteristic of the first and second disturbances.

In accordance with other various embodiments, a method for acoustic detection is provided. The method includes configuring a flow conduit to allow fluid flow therethrough and positioning within the flow conduit a flow disrupter configured to impart a flow disturbance to the fluid flow. The method also includes providing a first sensor for positioning within the flow conduit at a first position, wherein the first sensor is responsive to first disturbances including at least one of a disturbance of the fluid flow, pressure fluctuations in the flow conduit, acoustic waves, or acoustic energy in the flow conduit, and the first sensor is configured to generate signals characteristic of the first disturbances. The method further includes providing a second sensor for positioning within the flow conduit at a second position, wherein the second sensor is responsive to second disturbances including at least one of a disturbance of the fluid flow, pressure disturbances. The method additionally includes configuring the first and second sensors to distinguish between signals characteristic of the first and second disturbances with a processor.

### BRIEF DESCRIPTION OF THE DRAWINGS

FIG. 1 is schematic illustration of a flow sensor in accordance with various embodiments.

FIG. 2 is a graph illustrating a curve of error versus distance in accordance with various embodiments.

FIG. 3 is a schematic illustration of a ventilation apparatus in accordance with various embodiments.

FIG. 4 is a schematic illustration of a flow sensor in accordance with various embodiments.

FIG. 5 is schematic illustration of another flow sensor in accordance with various embodiments.

FIG. 6 is a diagram illustrating flow disturbance detection in accordance with various embodiments.

FIG. 7 is a block diagram illustrating signal isolation in accordance with various embodiments.

FIG. 8 is another block diagram illustrating signal isolation in accordance with various embodiments.

FIG. 9 is a flowchart of a method for acoustic detection in accordance with various embodiments using flow sensors.

FIG. 10 is a schematic illustration of another flow sensor in accordance with various embodiments.

FIG. 11 is a schematic illustration of another flow sensor in accordance with various embodiments.

FIG. 12 is a schematic illustration of another flow sensor in accordance with various embodiments.

### DETAILED DESCRIPTION

The following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Although the various embodiments may be described herein within a particular operating environment, for example in connection with a particular ventilation and/or respiratory machine, it should be appreciated that one or more embodiments are equally applicable for use with other configurations and systems. For example, the various embodiments may be used in different medical and non-medical applications.

Various embodiments provide systems and methods for acoustic detection using one or more flow sensors. For example, various embodiments use flow sensors to detect acoustic noise, such as snoring (also referred to herein as snore detection), other sounds from a user of ventilation and/or respiratory machines, such as continuous positive airway pressure (CPAP) machines and variable positive airway pressure (VPAP) machines, as well as sounds from the machines (e.g., fan sounds), among others. At least one technical effect of various embodiments is an increased comfort level for the user of these machines.

FIG. 1 illustrates schematically a flow sensor assembly 110 in accordance with an embodiment that may be used, for example, with a CPAP or VPAP machine to control the flow of air to a user, such as to provide varying levels of positive airway pressure to a user when sleeping. The flow sensor assembly 110 in various embodiments is configured to identify one or more acoustic signals. In general, the sensors 120 and 126 of the flow sensor assembly 110 are responsive to first and second disturbances, respectively, to generate signals characteristic of the first and second disturbances. For example, the disturbances may include a disturbance of the fluid flow, pressure fluctuations in a flow conduit 112, acoustic waves (e.g., audible sound waves or ultrasonic acoustic waves), and acoustic energy, among others. Accordingly, a disruption in a fluid flow creates certain characteristics, which may include vortices or pressure/flow pulses that can be sensed and analyzed. In particular, fluid flow will have a certain direction, velocity, pressure, and temperature associated therewith. By placing a disruption in the fluid stream, the velocity is altered, as are the pressure and temperature. These changes can be detected and analyzed to determine and distinguish between the different signal characteristics of the first and second disturbances. For example, in various embodiments, a processor 136 is operably connected to the sensors 120 and 126 to receive and distinguish between signal characteristics of the first and second disturbances, which in some embodiments, includes isolating the signals characteristic of sounds from the signals characteristic of the disturbance of the fluid flow.

With respect particularly to the flow sensor assembly 110 that includes the pair of sensors 120, 126, which may be different types of sensing elements as described in more detail herein, each of the sensors 120, 126 is positioned within the conduit 112 that has an upstream opening 114 and a downstream opening 116. It should be understood that the terms “upstream” and “downstream” are relative terms that are related to the direction of flow 118, such as the flow of air. Thus, in some embodiments, if the direction of flow 118 extends from element 116 to element 114, then element 116 is the upstream opening and element 114 is the downstream element. For ease of description, the upstream side of the flow sensor assembly 110 will be the side closest to the opening 114 and the downstream side of the assembly will be the side closest to the opening 116.

A flow disrupter 134 is positioned within the conduit 112, which in the illustrated embodiment is equidistant between the sensors 120, 126. However, the sensors 120, 126 may be positioned at different distances from the flow disrupter 134. In one embodiment, the sensors 120, 126 are coupled or mounted on a printed circuit board (PCB) 132 at, respectively, first and second positions 122, 128. In operation, the flow disrupter 134 is configured to form turbulence within the flow stream, such as, for example, waves or eddies, or vortices, where the flow is mostly a spinning motion about an axis (e.g., an imaginary axis), which may be straight or curved. Additionally, vortex shedding, for example, occurs as an unsteady oscillating flow that takes place when a fluid such as air flows past a blunt body such as the flow disrupter 134 at certain velocities, depending to the size and shape of the body. As described in more detail herein, the flow disrupter 134 may be a passive or active device.

In various embodiments, the sensors 120, 126 are configured to acquire measurements and send signals to, respectively signal conditioners 124, 130. The signal conditioners 124, 130 condition the signals by, for example, filtering or amplifying the received signals, prior to sending the signals to anti-abasing filters and the processor 136 for analysis. For example, the signals generated by the sensors 120, 126 are communicated to the processor 136 that is configured to isolate signals characteristic of the fluid flow from noise due to turbulent flow (which may result from different sources of acoustic noise or energy), such as to detect the signals characteristic of sound based on a cross-correlation of the signals from the sensors 120, 126.

It should be noted that the locations of one or more of the first and second positions 122, 128, the shape of the flow disrupter 134, the positioning of the flow disrupter 134 relative to the sensors 120, 126 and within the conduit 112, and the size and positioning of the PCB 132 may be varied as desired or needed to generate particular disturbances within the conduit 112 and to allow measurement of the disturbances, such as the frequency of the disturbances to distinguish between flow and sound. For example, one or both of the sensors 120, 126 are positioned a defined distance from the flow disrupter 134 to allow detection of the turbulent vortices or pressure/flow pulses caused by the flow disrupter 134, in particular, within a distance where the disturbances have been formed, but not decayed to the point of being undetectable. These disturbances can be largely turbulent in nature. Thus, there are regions located at a distance from the flow disrupter 134, at which the sensors 120, 126 are positioned and which have a geometrical relationship wherein the error in the sensor reading is reduced or minimized. The relationship between error and the distance the sensor is from the flow disrupter 134 is illustrated in the graph 200 of FIG. 2. As can be seen by the curve 202, there is a region 204 where the error of the sensor output is low and relatively unchanging, which is where the sensors 120, 126 are positioned. In one embodiment, the sensors 120, 126 are located equidistant from the flow disrupter 134. It should be noted that although only one flow disrupter 134 is shown in FIG. 1, two or more flow disrupters 134 may be utilized within the conduit 112.

In operation, the characteristics, such as the vortices or disturbances in the form of pulses, of flow that can be determined are, for example, flow speed, flow direction, the pressure of the flow, the temperature of the flow, the change in velocity of the flow, the change in pressure of the flow, and the heat transfer of the flow. Thus, the sensors 120, 126 can be any type of sensor capable of sensing any one or more of these disturbances. For example, the sensors 120, 126 may be configured to determine pressure, temperature, change in pressure, change in temperature, or change in flow rate. In one embodiment, the sensors 120, 126 are pressure sensors. In another embodiment, the sensors 120, 126 are heaters. In yet another embodiment, the sensors 120, 126 are microelectromechanical (MEMS) devices.

It should be noted that two sensors 120, 126 may not be used in some embodiments, wherein only a single sensor 120 or 126 instead may be used. However, in various embodiments, the two sensors 120, 126 are used to allow a determination of the direction of a flow of fluid, as well as to differentiate ambient noise from other noise caused by turbulence, which can reduce the amount of error inherent in the analysis of the signals.

In some embodiments, such as wherein the flow sensor assembly 110 forms part of a CPAP or VPAP machine, a fan 142 (and control motor) are in fluid connection with the conduit 112 to generate a flow of fluid, in this embodiment, air, through the conduit 112. A mask 144 is in fluid connection with the conduit 112, which may be configured as or form part of a flexible tube that is fluid connection with the fan 142. The fan 142 is also communicatively coupled to the processor 136 to allow control of the fan 142. For example, the processor 136 uses signals received from the sensors 120, 126 to control the operation of the fan 142, such as to vary the level of the speed of the fan 142 or turn the fan 142 on or off, which controls a flow of air to a the mask 144 that may be worn by a person. In some embodiments, the flow of air through the conduit 112 to the mask 144 is controlled based on whether a person to which the mask 144 is connected is snoring, as determined by analysis of the signals from the sensors 120, 126 characteristic of different measured disturbances within the conduit 112.

For example, FIG. 3 schematically illustrates a ventilation assembly 300 in accordance with one embodiment. The ventilation assembly may be, for example, a CPAP or a VPAP machine. The ventilation assembly 300 includes the flow sensor assembly 110, a fan 302 (which may be embodied as the fan 142 shown in FIG. 1), a tube 304, and a mask 306 (which may be embodied as the mask 144 shown in FIG. 1). Optionally, a humidifier 308 can be included upstream of the tube 304. In addition, a pressure sensor 310 may be located within the fan 302. While illustrated upstream of the fan 302, the flow sensor assembly 110 may instead be positioned further downstream, for example within the tube 304.

In operation, there is an ambient pressure P_{amb} in the fluid flow 312 entering the flow sensor assembly 110. The fan 302 is provided to create a higher pressure P_{M} that is used to facilitate the movement of a fluid through the tube 304 to the mask 306. There will be a pressure drop (ΔP) along the tube 304 between the higher pressure P_{M} at the fan 302 and the lower pressure P_{P} at the patient wearing the mask 306. The ventilation assembly 300 is configured to maintain a constant or substantially constant pressure P_{P}. In various embodiments, a processor 314 (which may be embodied as the processor 136 shown in FIG. 1) is operably connected to the flow sensor assembly 110 and fan 302 to control the amount of air supplied through the tube 304, which may be varied, such as based on a detected acoustic noise, such as snoring of the patient. For example, the speed of the fan 302 may be varied, or turned on or off, to control the pressure P_{P}.

It should be noted that variations and modifications are contemplated. For example, different types of sensors 120, 126 may be used. Additionally, different types of flow disrupters 134 may be used, such as passive actuators or active actuators that are configured to impart a disturbance to the flow within the conduit 112. For example, FIG. 4 illustrates the flow sensor assembly 110 having a different flow disrupter 400. The flow disrupter 400 includes a first part 402 separated from a second part 404 (e.g., each being half-cylindrical in shape) by a flow separator 406, such as to form a channel or gap therebetween. The first and second parts 402, 404 in one embodiment are blunt flow disrupters. Although shown as being separate elements, the first and second parts 402, 404 instead may be opposite sides of a single flow disrupter that has a flow separator formed in a middle portion thereof.

The flow disrupter 400 may be positioned orthogonal to the fluid flow direction through the conduit 112, such as coupled on opposing sides of the conduit 112. Additionally, the PCB 132 may include fastening elements (e.g., arms) to allow proper positioning within the conduit 112 and coupled to sides of the conduit 112.

As another example, two or more temperature sensors may be provided as shown in FIG. 5. The temperature sensors can be, for example, any two of a plurality of sensors 536, 538, and 540. The combination of two temperature sensors are used in various embodiments to determine the direction of flow as either being in a direction 544 or a direction 546. If, for example, the direction of flow is in the direction 544, then the temperature sensor 536 will not detect heat from the sensor 126, which in this embodiment is a heater maintained at a constant temperature, but the temperature sensors 538, 540 will detect heat from, respectively, the sensor 126 and the sensor 120, also being heaters in this embodiment. Thus, the difference in the amount of heat detected or measured by two of the temperature sensors 536, 538, 540 can determine the direction of flow.

Alternatively, a secondary flow disrupter 542 may be positioned near one of the sensors 120, 126. For one flow direction, the secondary flow disrupter will affect the DC values of one of the sensors, while in the opposite flow direction there will be no effect to the DC values of either of the sensors. For example, for the flow direction 544, the illustrated secondary flow disrupter 542 will affect the DC value of the sensor 126, but with no or negligible effect on the sensor 120. For the flow direction 546, the illustrated secondary flow disrupter 542 will not affect the DC values of either of the sensors 120, 126.

In another embodiment, the direction of flow can be determined based on an amount of flow disruption. In particular, the flow disrupter 134 will create, as a result of being in the fluid path, a higher flow downstream than is upstream. Thus, the upstream sensor (sensor 126 for the flow direction 544, and sensor 120 for the flow direction 546) will measure a lower flow rate than the downstream sensor.

As examples of other variations, while the PCB 132 may have arms, the PCB 132 may be coupled to a lower portion of the conduit 112 (shown in FIG. 1) using anchors or other fasteners. It should be noted that signals from the PCB 132 and the sensors 120, 126 may be communicated from the conduit 112 through electrical pins (not shown). Additionally, the conduit 112 may further include a straightener section that conditions the flow through the conduit 112. For example, the straightener section may include a screen to assist in transitioning turbulent flow back into laminar flow.

Various embodiments provide for determining simultaneously or concurrently, responses to acoustic energy and fluid flow as measured, for example, by the sensors 120, 126. For example, FIG. 6 illustrates a sensor 600 (which may be embodied as the flow sensor 120 shown in FIG. 1), which is downstream of a flow disrupter 602 (which may be embodied as the flow disrupter 134 shown in FIG. 1). It should be noted that the flow disrupter 602 in some embodiments may be a passive device, for example, a structure within the conduit 112 (shown in FIG. 1) that does not move and which creates a disturbance in the fluid flow within the conduit 112. In other embodiments, the flow disrupter 602 may be an active device, for example, a structure (e.g., cylinder) that moves, such as rotates, to create a disturbance in the fluid flow within the conduit 112. In some embodiments, the active structure may create a pulse wave (e.g., a heat wave) within the conduit 112. It should be noted that in some embodiments, the flow disturbance is created by the conduit 112. For example, in these embodiments, the conduit 112 is configured (e.g., shaped) such that a flow disturbance is created therein. Thus, a portion of the conduit 112 (e.g., a protrusion) may be the flow disrupter 602.

In response to the created disturbance within the conduit 112, the sensor 600 generates an output signal 604, which in some of the various embodiments is a sinusoidal waveform resulting from the periodic nature of the vortices 606 of the disturbance (which corresponds to the peaks in the output signal 604). This disturbance pattern may be referred to as a vortex street, which is a repeating pattern of swirling vortices caused by the unsteady separation flow of a fluid around a blunt object, in this case the flow disrupter 602 (turbulent flow having higher Reynolds numbers (Re) than laminar flow). Thus, the sensor 600 is configured to detect vortices in the flow, and in particular, vortices resulting from the vortices caused by the flow disrupter 602. As should be appreciated, the sensor 126 (shown in FIG. 1), which is upstream of the flow disrupter 134, will not detect any vortices in the flow caused by the flow disrupter 602 as the flow disrupter 602 is downstream therefrom.

For example, as illustrated in FIG. 7, a sensor 700 (which may be embodied as the flow sensor 120 shown in FIG. 1), is downstream of a flow disrupter (e.g., the flow disrupter 134 shown in FIG. 1) and detects a corresponding fluid flow disturbance resulting from the flow disrupter. The sensor 702 is upstream of the flow disrupter and accordingly can be configured not to detect the fluid flow disturbance caused by the flow disrupter. Accordingly, because the flow disrupter is between the sensors 700 and 702, only the downstream sensor, which in this example is the sensor 700, detects the fluid flow disturbance created by the flow disturber.

Additionally, an acoustic disturbance likewise may be generated within the fluid flow path, such as within the conduit 112. For example, sounds waves or acoustic energy may be generated within the conduit 112. In some embodiments, the acoustic disturbances are generated from the downstream side of both of the sensors 700, 702 such that both of the sensors 700, 702 detect the acoustic disturbance. In a medical setting, for example, the acoustic disturbances may be generated by a patient connected to a CPAP or VPAP machine including the sensors 700, 702 or by the machine. The acoustic disturbances may be, for example, sounds generated by the patient indicative that the patient is having problems (e.g., problems breathing), which in some embodiments may be manifested in snoring. However, it should be appreciated that the sensors 700, 702 are configured to detect different types of acoustic disturbances, for example, within a defined frequency range and/or amplitude range. In other embodiments, the acoustic disturbance may be generated not by the patient and not from the downstream side. For example, the CPAP or VPAP machine (e.g., the fan 302 shown in FIG. 3) or peripheral components may generate noise, such as when the machine or components are not functioning properly.

In these embodiments, the acoustic disturbance is detected by both sensors 700, 702. In particular, the acoustic disturbance may propagate within the conduit 112 in one or both directions, such that both of the sensors 700, 702 detect the acoustic disturbance. Thus, the sensor 700 simultaneously or concurrently detects a disturbance of the fluid flow and an acoustic disturbance having disturbance components from both the fluid flow disturbance and acoustic disturbance. The sensor 700 is configured to generate output signals 706 characteristic of these detected disturbances. Additionally, the sensor 702 (the upstream sensor in this embodiment) only detects the acoustic disturbance, thus, having only a disturbance component from the acoustic disturbance. The sensor 702 is configured to generate output signals 708 characteristic of this detected disturbance.

The processor 704 (which may be embodied as the processor 136 shown in FIG. 1) is configured to receive the outputs signals 706, 708 from the sensors 700, 702, corresponding to the detected disturbances, which in the illustrated embodiment have different disturbance components. For example, the output signals 706, 708 may be signal waveforms corresponding to the detected disturbances within the conduit 112. The processor 704 is configured to distinguish between signals (e.g., signal signatures) characteristic of the disturbances corresponding to the disturbance components. For example, as described in more detail herein, the processor 704 is configured to isolate signals characteristic of sound or acoustic noise from signals characteristic of disturbance of fluid flow. In some embodiments, the processor 704 is configured to isolate one or more signals to identify or sense the presence of patient noise, such as snoring, for example, based on the acoustic or spectral properties of snore, or other noise, such as from the ventilation machine or patient. It should be noted that the processor 704 is configured to isolate the presence of acoustic energy or sound of interest (e.g., snoring) from acoustic energy or sound not of interest, such as noise from fan operation or other acoustic interference.

In various embodiments, the processor 704, based on the received signals 706, 708, is configured to detect signals characteristic of acoustic energy or sound based on one or more mathematical functions of the signals 706, 708, for example, a difference function, a linear function or a non-linear function, among others. In particular, a known signal signature (e.g., sound signature or snore signature) may be identified by the processor 704 using the signals 706, 708. For example, a snore signal may be identified after removing the flow disturbance signal by determining an asymmetric periodic oscillation of a sounds wave in the time domain or power peaks of various amplitudes in the frequency domain. Some examples of different methods are described in co-pending patent application Ser. No. 13/247,107 filed on Sep. 28, 2011, entitled “FLOW SENSOR WITH MEMS SENSING DEVICE AND METHOD FOR USING SAME”.

In some embodiments, a particular sound signal signature, such as a snore signal signature, may be determined by identifying a difference in frequency content or characteristics using the signals 706, 708. In some embodiments, because the signals 706, 708 are correlated, a determination is made as to the difference in the signals 706, 708, which correspond to differences in the signals detected with and without flow disturbances, respectively, created by the flow disturber. In particular, the component or portion of the disturbance due to acoustic energy or sound (e.g., snore) remains correlated in the signals 706, 708.

Accordingly, acoustic detection using flow sensors may be provided by isolating one or more signal characteristics. For example, acoustic energy or sound creates or is manifested in flow disturbances. In various embodiments, a known flow disturbance, for example, a periodic flow disturbance, which may be characterized by the signal 802 shown in FIG. 8, is generated by a flow disturber (e.g., the flow disturber 134). The flow disturbance is generated such that a subset of sensors, which is less than a total number of sensors, detects the intentionally generated flow disturbance. For example, with reference to FIG. 1, the flow disturber 134 is positioned within the conduit 112 such that only one of the flow sensors 120 of the plurality of flow sensors 120, 126 detects the flow disturbance characterized by the signal 802. It should be noted that the placement of the various sensors and one or more flow disturbers may be varied. However, in various embodiments, at least one or more of a plurality of sensors is subject to the created flow disturbance and at least one or more different ones of the plurality of sensors is not subject to the created flow disturbance. For example, the sensor 806 is subject to the intentional disturbance represented by the signal 802, while the sensor 808 is not subject to the intentional disturbance.

With respect to the acoustic energy or sound manifested in flow disturbances, represented by the signal 804, both of the sensors 806, 808 detect or sense this disturbance. In particular, the flow disturbances from the acoustic energy or sound are propagated within the fluid flow such that at least one sensor 806 that detects the intentional disturbances also detects the disturbances from the acoustic energy or sound and at least one sensor 808 that does not detect the intentional disturbances likewise detects the disturbance from the acoustic energy or sound. Thus, the sensor 806 in this example simultaneously or concurrently detects both disturbances, which may be manifest in combined signals having signal characteristics from both types of disturbances. The characteristics from both types of disturbances may be combined within the signals detected by the sensor 806.

Thus, both sensors 806, 808 include within the detected signals, a component or characteristic resulting from or attributable to the acoustic energy or sound. This component or characteristic resulting from or attributable to the acoustic energy or sound may be isolated, such as using a detected or sensed signal and the corresponding signal profile of that characteristic. For example, because the sensor 808 detects only the disturbance from the acoustic energy or sound, the signal profile or component for that disturbance is known and can be removed from (e.g., subtracted from) the signal including the signal components from both the intentional disturbance and the disturbance from the acoustic energy or sound, resulting in a signal having signal components or a profile caused by the vortices of flow from the intentional disturbance. Accordingly, by adding the outputs of the sensors 806, 808 and then subtracting therefrom the absolute value of the difference of the outputs from the sensors 806, 808, the resulting signals contain the signal profile or components that are characteristic of and resulting from the acoustic energy or sound, such as illustrated by the signal 810. These signal components or profiles may, for example, be compared to known acoustic signal components or profiles for different noise sources to determine a corresponding source of the acoustic energy or sound.

It should be noted that different signal separation techniques also may be used and the ones described herein are merely for example.

A method 900 for acoustic detection using flow sensors in accordance with an embodiment is illustrated in FIG. 9. The method 900 may be implemented in various different applications having fluid flow, such as fluid transport (e.g., oil and gas transport), medical treatment (e.g., CPAP or VPAP machines), among other medical and non-medical applications. The method 900, for example, may employ structures or aspects of various embodiments discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

The method 900 includes configuring a flow conduit to allow fluid flow therethrough at 902. For example, a tube or other fluid transport member may be configured to allow any type of fluid flow therethrough, such as a gas or liquid. In some embodiments, such as in medical applications, the conduit may allow airflow therethrough at varying pressure levels. The method 900 may be implemented with any source and destination of the fluid flow.

The method 900 also includes positioning within the conduit at 904 a flow disrupter configured to impart a flow disturbance to the fluid flow. The flow disrupter may be a separate component mounted within the conduit in some embodiments. In other embodiments, the flow disrupter may form part of or be integrally formed with the conduit. The flow disrupter may impart the flow disturbance due to the presence of the flow disrupter (e.g., non-moving component) and optionally may move, such as rotate or tilt within the conduit. The flow disrupter may be sized and shaped differently, such as based on the fluid flowing through the conduit or the type of disturbance to be imparted to the fluid flow. Additionally, more than one flow disrupter may be placed within the conduit at different axial locations along the conduit.

The method 900 also includes disposing at 906 a first sensor within the conduit at a first position, which is responsive to first disturbances. For example, the first sensor may be the sensor 120 (shown in FIG. 1), which is placed downstream of the flow disrupter. The sensor may be any type of sensing device as described in more detail herein. In one embodiment, the first sensor is configured to detect or sense a first disturbance that includes at least one of a disturbance of the fluid flow in the conduit, pressure fluctuations in the conduit, acoustic waves or acoustic energy in the conduit. In response to the detecting or sensing the first disturbance, the first sensor is configured to generate signals characteristic of the first disturbance(s).

The method 900 also includes disposing at 908 a second sensor within the conduit at a second position, which is responsive to second disturbances. For example, the second sensor may be the sensor 126 (shown in FIG. 1), which is placed downstream of the flow disrupter. The sensor may be any type of sensing device as described in more detail herein. In one embodiment, the second sensor is configured to detect or sense a second disturbance that includes at least one of a disturbance of the fluid flow in the conduit, pressure fluctuations in the conduit, acoustic waves or acoustic energy in the conduit. In response to the detecting or sensing the second disturbance, the second sensor is configured to generate signals characteristic of the second disturbance(s).

It should be noted that in one embodiment, the first and second sensors are positioned with the flow disrupter therebetween. Thus, depending on the direction of flow of fluid through the conduit, the first and second sensors are upstream and downstream, or vice versa, respectively, of the flow disrupter. It also should be noted that the distance between the sensors and the distance between each of the sensors and the flow disrupter may be varied as desired or needed, for example, based on the acoustic energy or sound to be detected.

The method 900 also includes distinguishing between signals characteristic of the first and second disturbances at 910. For example, as described herein, different sound disturbances may be distinguished from non-sound disturbances of the flow within the conduit. In one embodiment, flow within the conduit may be sensed independently of acoustic energy or acoustic waves and signals characteristic of the acoustic energy or acoustic waves may be isolated from signals characteristic of the disturbance of the fluid flow, for example, the intentional disturbance(s) as described herein. Different functions or signal separation techniques may be used to isolate the signals. In some embodiments, a cross-correlation of the signals from the first and second sensors may be used to detect the acoustic signal characteristics or signal components.

Variations and modifications are contemplated. For example, FIGS. 10-12 illustrate different embodiments. FIGS. 10 and 11 illustrate a flow sensor assembly 1000 that includes a bypass channel 1002. In this embodiment, the flow disrupter 134 is shown within the conduit 112 to impart a disturbance to the flow of fluid within the conduit 112. However, different flow disrupters may be provided as described herein. Additionally, the conduit 112 generally defines a main channel and the bypass channel 1002 defines a secondary channel that has a smaller inner dimension (e.g., smaller inner diameter) than the conduit 112. For example, the bypass channel 1002 may be a micro-channel having a significantly smaller inner diameter than the conduit 112, such that fluid flow through the bypass channel 1002 is forced to be laminar. The bypass channel 1002 may be formed integrally with the conduit 112 or coupled thereto, for example, by cutting openings into the conduit 112 and securing the bypass channel 1002 thereto covering the openings.

One or more sensors 1004, 1006 are positioned within the bypass channel 1002, which may be similar to or embodied as the sensors 120, 126. It should be noted that one of the sensors 1004 is positioned closer to a first opening 1008 of the bypass channel 1002 and the other sensor 1006 is positioned closer to a second opening 1010 of the bypass channel 1002. It also should be noted that although fluid flow is illustrated as going from the opening 1008 to the opening 1010, fluid flow may be reversed within the bypass channel 1002 as described in more detail below.

The sensors 1004, 1006 are configured to generate outputs signals (illustrated as signals 1012, 1014, respectively) as described herein and that may be conditioned as described herein. However, as described in more detail in connection with FIG. 11, during operation, in various embodiments, only one of the sensors 1004, 1006 is provided and/or outputting a signal, which is received by a controller 1016, which may be embodied as the processor 136 (shown in FIG. 1).

In operation, the flow disturber 134 imparts a disturbance to the flow within the conduit 112. In the case of a passive flow disturber, for example, the imparted disturbance is related to the geometric dimensions of the flow disturber, illustrated as G₁ and G₂. Additionally, the disturbance travels within the conduit, for example, a distance D, in a given time period. In some embodiments, disturbances created by the flow disturber 134 travel within the conduit 112 at a speed between about 0.1 meters/second (m/s) to about 10 m/s. Thus, for example, the disturbance will travel the length L between the first and second openings 1008, 1010 in a time related to that speed. However, acoustic disturbances (e.g., longitudinal acoustic waves), for example, travel at a much higher rate of speed, namely about 340 m/s.

Thus, the bypass channel 1002 may be used, for example, as a filter, to remove disturbances due to the flow disrupter 134, such as to remove the vortices within the flow to create a laminar flow within the bypass channel 1002. The frequency of the oscillations within the bypass channel 1002 may be used to determine if the disturbances passing by the openings 1008, 1010 are due to the flow disrupter 134 or other disturbances, for example, acoustic waves. For example, the oscillations of the fluid flow back and forth within the bypass channel 1002 are a result of the changing pressures at the openings 1008, 1010. If the oscillations are determined to be above a threshold value, then the oscillations are not caused by disturbances from the flow disrupter 134, but other non-flow disrupter disturbances, such as resulting from acoustic waves or acoustic energy. Thereafter, other analysis or methods described herein may be used to determine other information relating to the disturbances.

In various embodiments, the bypass channel 1002 is in fluid connection with the flow conduit 112 and arranged to have a geometrical relationship relative to the flow conduit 112 and the flow disrupter 134 to affect at least some flow characteristics in the bypass channel 1002. In the illustrated embodiment, only one of the sensors 1004 is obtaining measurements as described herein. However, in other embodiments, only one sensor, for example, the sensor 1004 is disposed within the bypass channel 1002 at a first position (with no sensor 1006 positioned at a second position) and responsive to first disturbances including at least one of a disturbance of the fluid flow, pressure fluctuations in the flow conduit 112, acoustic waves, or acoustic energy in the flow conduit 112. The sensor 1004 is configured to generate signals characteristic of the first disturbances as described herein. However, in other embodiments, only the sensor 1006 is disposed within the bypass channel 1002 at the second position and responsive to disturbances including at least one of a disturbance of the fluid flow, pressure fluctuations in the flow conduit 112, acoustic waves, or acoustic energy in the flow conduit 112. The sensor 1006 is configured to generate signals characteristic of the disturbances as described herein.

It should be noted that a geometrical relationship may be selected to affect a functional relationship between a flow pressure at an entrance of the bypass channel 1002, namely at the opening 1008 and a flow pressure at an exit of the bypass channel 1002, namely at the opening 1010. Thus, the size and spacing of the openings 1008, 1010 may be configured based on, for example the particular characteristics of interest.

Variations and modifications are also contemplated to the flow sensor assembly 1000. For example, two or more temperature sensors may be provided as shown in FIG. 12 (two temperature sensors 1200, 1202 are shown) that output temperature signals 1204, 1206, respectively. The combination of two temperature sensors 1200, 1202 is used in various embodiments to determine the direction of flow (as described herein) within the bypass channel 1002. For example, the difference in the amount of heat detected or measured by two of the temperature sensors 1200, 1202 can determine the direction of flow as described herein.

Thus, various embodiments use flow sensors, such as in a flow sensor assembly for acoustic detection. For example, if the flow sensor assembly is being used in a CPAP or VPAP machine, the sensors of various embodiments may be used to detect the sound of snoring. However, the various embodiments may be implemented in different types of flow sensor systems. For example, in some embodiments, the flow sensor system may include a bypass channel.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and/or non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, the embodiments are by no means limiting and are exemplary embodiments. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A flow sensor assembly comprising:
a flow conduit configured to allow fluid flow therethrough;
a flow disrupter configured to impart a flow disturbance to the fluid flow;
at least one of a first sensor or a second sensor, wherein,
the first sensor is disposed within the flow conduit at a first position, the first sensor being responsive to first disturbances including at least one of a disturbance of the fluid flow, pressure fluctuations in the flow conduit, acoustic waves, or acoustic energy in the flow conduit, the first sensor configured to generate signals characteristic of the first disturbances;
the second sensor is disposed within the flow conduit at a second position, the second sensor being responsive to second disturbances including at least one of a disturbance of the fluid flow, pressure fluctuations in the flow conduit, acoustic waves, or acoustic energy in the flow conduit, the second sensor configured to generate signals characteristic of the second disturbances; and
a processor operably coupled to at least one of the first or second sensors, wherein the processor is configured to distinguish between signals characteristic of the first and second disturbances.

2. The flow sensor assembly of claim 1, wherein the processor is configured to sense the fluid flow in the conduit independent from acoustic waves or acoustic energy in the fluid flow.

3. The flow sensor assembly of claim 1, wherein the processor is configured to isolate signals characteristic of sound from signals characteristic of the disturbance of the fluid flow.

4. The flow sensor assembly of claim 3, wherein the sound is due to snoring and the processor is configured to detect the presence of snoring.

5. The flow sensor assembly of claim 4, wherein the processor is configured to detect the presence of snoring based on one of acoustic properties or spectral properties of snoring.

6. The flow sensor assembly of claim 1, further comprising a fan in fluid connection with the flow conduit, a tube in fluid connection with the fan, and a mask in fluid connection with the tube, wherein the processor is configured to control operation of the fan in response to signals characteristic of the acoustic waves or acoustic energy.

7. The flow sensor assembly of claim 1, further comprising a fan in fluid connection with the flow conduit, a tube in fluid connection with the fan, and a mask in fluid connection with the tube, wherein the processor is configured to sense the fluid flow independent of operation of the fan and responsive to signals caused by sound emanating from the vicinity of the mask.

8. The flow sensor assembly of claim 1, further comprising a fan in fluid connection with the flow conduit, a tube in fluid connection with the fan, and a mask in fluid connection with the tube, wherein the processor is configured to control operation of the fan in response to signals characteristic of snoring based on distinguishing between signals characteristic of the first and second disturbances.

9. The flow sensor assembly of claim 1, further comprising a fan in fluid connection with the flow conduit, a tube in fluid connection with the fan, and a mask in fluid connection with the tube, wherein the processor is configured to isolate the presence of snoring independent of acoustic interference including acoustic interference from operation of the fan.

10. The flow sensor assembly of claim 1, wherein the processor is configured to isolate signals characteristic of the fluid flow from noise due to turbulent flow.

11. The flow sensor assembly of claim 1, wherein the processor is configured to detect signals characteristic of vibration.

12. The flow sensor assembly of claim 1, wherein the processor is configured to detect signals characteristic of sound based on a cross-correlation of signals from the first and second sensors.

13. The flow sensor assembly of claim 1, further comprising the first and second sensors, wherein the flow disrupter is positioned within the flow conduit between the first and second sensors.

14. The flow sensor assembly of claim 1, wherein the flow disrupter comprises one of a blunt flow disrupter or a planar flow disrupter.

15. The flow sensor assembly of claim 1, wherein the flow disrupter comprises a first part separated from a second part forming a channel or gap therebetween.

16. The flow sensor assembly of claim 1, wherein the first and second sensors are microelectromechanical (MEMS) sensors.

17. The flow sensor assembly of claim 1, further comprising a bypass channel in fluid connection with the flow conduit and arranged to have a geometrical relationship relative to the flow conduit and the flow disrupter and configured to affect at least some flow characteristics in the bypass channel.

18. The flow sensor assembly of claim 17, wherein the geometrical relationship affects a functional relationship between a flow pressure at an entrance of the bypass channel and a flow pressure at an exit of the bypass channel.

19. A method for acoustic detection comprising:
configuring a flow conduit to allow fluid flow therethrough;
positioning within the flow conduit a flow disrupter configured to impart a flow disturbance to the fluid flow;
providing a first sensor for positioning within the flow conduit at a first position, the first sensor configured to detect first disturbances including at least one of a disturbance of the fluid flow, pressure fluctuations in the flow conduit, acoustic waves, or acoustic energy in the flow conduit, the first sensor configured to generate signals characteristic of the first disturbances;
providing a second sensor for positioning within the flow conduit at a second position, the second sensor configured to detect second disturbances including at least one of a disturbance of the fluid flow, pressure fluctuations in the flow conduit, acoustic waves, or acoustic energy in the flow conduit, the second sensor configured to generate signals characteristic of the second disturbances; and
configuring the first and second sensors to distinguish between signals characteristic of the first and second disturbances with a processor.

20. The method of claim 19, further comprising isolating signals characteristic of sound from signals characteristic of the disturbance of the fluid flow.

21. The method of claim 20, wherein the sound is snoring and further comprising detecting the presence of snoring using the distinguishing.

22. The method of claim 21, further comprising controlling operation of a fan of a human ventilation machine in response to detecting the presence of the snoring.

23. The method of claim 19, wherein providing at least one of the first or second sensors comprises providing at least one of the first or second sensors for positioning in a bypass channel in fluid connection with the flow conduit, and configuring the bypass channel to have a geometrical relationship relative to the flow conduit and the flow disrupter to affect at least some flow characteristics in the bypass channel.

24. A non-transitory computer readable storage medium for acoustic detection with flow sensors in a flow conduit using a processor, the non-transitory computer readable storage medium including instructions to command the processor to:
receive signals characteristic of first disturbances from a first sensor within the flow conduit at a first position, the first sensor being responsive to the first disturbances including at least one of a disturbance of the fluid flow, pressure fluctuations in the flow conduit, acoustic waves, or acoustic energy in the flow conduit;
receive signals characteristic of second disturbances from a second sensor within the flow conduit at a second position, the second sensor being responsive to the second disturbances including at least one of a disturbance of the fluid flow, pressure fluctuations in the flow conduit, acoustic waves, or acoustic energy in the flow conduit, the second sensor configured to generate signals characteristic of the second disturbances; and
distinguish between signals characteristic of the first and second disturbances.
